(19) United States
(12) Patent Application Publication
(10) Pub. No.: US 2011/0302253 A1
(43) Pub. Date: Dec. 8, 2011

(54) Method of and system for advising level of availability in a digital communication

(75) Inventors: Kari Simpson-Anderson, Kanata (CA); Ron Setzer, Gilbert, AZ (US)

(73) Assignee: Mitel Networks Corporation

(21) Appl. No.: 12/802,341

(22) Filed: Jun. 4, 2010

(51) Int. Cl. G06F 15/16

(52) U.S. Cl. 709/206

(57) ABSTRACT

A system and method is described where Instant Message (IM) and other semi-synchronous communication sessions may be tied to the user's current dynamic status in order to share with collaborating parties, the degree of attention that a user may provide to the session. IM allows for collaboration even when a user cannot provide his/her full attention to an exchange, however, it will increase the efficiency and avoid misunderstandings if the user can send updates on his current level of attention along with explanatory messages when there is a significant change in the user dynamic status. For example, if the user has to go to a meeting or receives an important telephone call during an IM session, the other party will be advised accordingly. Thus, recipients will not assume that they are being ignored or that the user has become frustrated with the exchange.

### COPYRIGHT NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF THE INVENTION

The present invention relates generally to collaborative communication technology and more specifically, deals with a system of and method for communicating the level of availability of a user participating in a digital communication.

### BACKGROUND TO THE INVENTION

Collaboration applications can be classified in several different manners. One useful way of classifying them is on the basis of the level of synchronicity of an interaction. This provides a measure of the degree of user attention that is involved or expected in an exchange. Synchronous interactions, such as telephone calls, require almost all of a user's attention. As such, they can be justified only for those matters that require immediate and current attention. Email on the other hand, can be classified as asynchronous. The participants in a collaborative exchange by Email have no expectation that their message will receive immediate attention. Email is suited for non-urgent matters whose consideration can be left for a suitable time. Between these extremes is a class of semi-synchronous applications. Instant Messaging (IM) is an example of such a medium. With IM, messages are exchanged with the expectation that there will be an immediate reply or at most a reply after a short interval. It is expected that the receiving user will be giving his/her attention to matters other than that of the collaborative exchange, but both parties expect that there will be an active exchange of messages. They will not expect the other side's full attention but they will also not expect that attention to their matter will be held in abeyance for an extended period.

Users typically partition their attention across multiple priorities during the course of their activities. For example, users in a business setting very often must interact in multiple overlapping exchanges, moving their attention from one exchange to another depending on the priorities of the current circumstances. Users will be using social conventions and expectations to justify and explain their current state of attention to any particular concern. They will expect others to understand why they cannot provide immediate and continuing attention to certain matters. They will expect others to understand when they have to suspend their attention to certain matters.

IM, with its semi-synchronous properties, fits well into this environment because it allows for continuing interactions and accommodates shifting attention. However, IM has the handicap of a limited scope for the sharing of social knowledge. If someone absents himself or herself from an IM exchange with no explanation, this may cause misunderstanding on the part of his/her collaborators that will hinder the effectiveness of the current and future exchanges. The user may have been interrupted with a very urgent matter but his/her IM collaborators will notice only that the exchange has stopped and may interpret this as indifference to their priorities. Similarly, a user may elect to take part in an IM exchange but as well be busy with other current matters. His/her attention to the IM exchange may be only sporadic. Their IM collaborators not having close contact to the user's context will have little information as to what to expect in the interaction. Their expectations regarding the priority of their current matter may not match that which the user expects or can provide, leading to misunderstandings and reduced effectiveness.

### BRIEF DESCRIPTION OF THE DRAWINGS

The present disclosure will be further understood from the following detailed description with reference to the drawings in which:

FIG. 1 illustrates a system for advising level of availability in a communication, in an embodiment of the invention;

FIG. 2 illustrates a table for storing Instant Message activity records;

FIG. 3 illustrates an exemplary Graphic User Interface (GUI) for setting user policies and rules;

FIGS. 4 through 6 are flow charts of a method of implementing an exemplary embodiment of the invention on receipt of a new IM message; and

FIG. 7 is a flow chart of a method of implementing an exemplary embodiment of the invention when an IM session is initiated by the user.

### DETAILED DESCRIPTION

Systems and methods disclosed herein provide a communication system for advising the level of availability of a user to handle a semi-synchronous communication, addressing at least some of the aforementioned disadvantages. The systems and methods also provide a way of sending explanatory messages related to user status, along with the availability update. Such features are useful for users and would make a vendor's telecom products more attractive in the marketplace.

Accordingly, this disclosure describes a method of semi-synchronous communication comprising establishing a semi-synchronous communication between a user and a second party, and responding to a change in the user's level of attentiveness to the semi-synchronous communication by: generating a status message addressed to the second party; populating the generated status message with an indicator of the user's new level of attentiveness, and an explanation for the change; and transmitting the explanatory status message to the second party. The “second party” is usually referred to in the art as a “distant party”, “distant end” or “remote party”. The “distant party” need not be a great distance away geographically; the term means “distant” in the sense that the parties cannot converse in a physically face-to-face manner so that IM communication is convenient and useful.

The method of the invention could be performed by a single communication device which supports semi-synchronous communication, by providing operability to respond to a change in a user's level of attentiveness. When the User's attentiveness level changes, the device may generate a status message addressed to another communication device on the semi-synchronous communication. The status message is populated with an indicator of the user's new level of attentiveness, and an explanation for the change in the level of attentiveness. The explanatory status message is then transmitted to the second communication device. Many existing communication devices have the memory and processing logic required to support such operability.

This disclosure also describes a system for semi-synchronous communication comprising: a first communication device having a user associated with it; a remote communication device; and a communication network interconnecting the first and the remote communication devices; where the first and the remote communication devices are operable to participate in a semi-synchronous communication. The first communication device is also operable to respond to a change in the user's level of attentiveness to the semi-synchronous communication by: generating a status message addressed to the remote communication device; populating the generated status message with an indicator of the user's new level of attentiveness, and an explanation for the change; and transmitting the explanatory status message to the remote communication device.

A number of other advantageous features are also described, for example, the system may operate regardless of whether the communication has been negotiated, started on receipt of a message, or started by the user wishing to send a message. The system is responsive to changes in the user's dynamic status, for example, whether he/she has placed or received a telephone call, or his/her calendar has indicated that he/she is in a meeting.

The system may tailor explanatory status messages in view of the identity or class of identity of remote parties it is communicating with or consider other context parameters of remote parties. Because IM participants are generally all corporate contacts (or closely connected to the user in some comparable organization), their presence may be tracked by a server and their identity or class distributed to registering clients. Policies may be set to handle incoming IMs based on the specific initiating party or group member. For example, if a member of Fred's immediate team sends him an IM while he is in a meeting, his IM AutoReply may indicate “I am in a meeting, expect replies to be short and sporadic.” If a member of the broader organization sends an IM to Fred, his IM AutoReply may indicate “I am in an important meeting and am not available for IM at this time” and will block any other attempts for the non-team member to contact him. To a social contact within the organization, Fred's IM AutoReply may simply indicate “I am busy, I'll get back to you when I can” and block attempts to contact him. Received IM messages may also be suppressed by the system, if, for example, the user is currently operating a slide show on his computer. Of course, a corresponding message may automatically be sent to the remote device in such a case.

Control of the system may be managed by setting user and administrator policies and rules, using a GUI or other interface. Typically, the administrator policies may override the user policies, though a conflict resolution mechanism may also be used.

As explained above, the semi-synchronous nature of Instant Messaging allows for collaboration even when a user cannot provide his/her full attention to an exchange. However, it will increase the efficiency and ease misunderstandings if the degree of attention can be shared among all participants. The sharing of information about the degree of attention that one can provide to an IM exchange can take several forms. Firstly, when an IM exchange is initiated a user must be able to make a decision as to whether or not to take part in it. The user can:
decline the exchange,
accept the exchange but only be able to give sporadic attention, or
accept the exchange and be able to fully participate in it.
   Of course, other levels may also be used, possibly providing more or less granularity.

In the first two cases, it will commonly be the situation that the user will wish to provoke a brief explanation as to the reason why he/she cannot give full attention to the exchange. So in the case of the decline, the user may reply with an IM of the form “I am sorry but I'm with a customer”. For the case in which only sporadic attention can be given, it may be desirable to send a message of the form “I'm busy now. I might not be able to reply very quickly.” Typically, the transmission of status updates and explanatory messages will be executed as an automated function based on certain dynamic criteria. However, it is also useful to allow the user, on the fly, to push canned (user configured) explanatory messages while in an active session.

Such messages provide the necessary social information to enable a collaborator to set his/her expectations as to the degree of attention to which the exchange can be provided. However, there are cases in which the manual provision of this information is difficult. For example, if a user is away from his/her desk at a meeting but his/her IM client is left open, it may cause collaborators to feel that they are bring ignored. As well, a user's priorities will in many cases change over the course of an exchange, for example, a user may go to a meeting or accept a telephone call while having open IM sessions. These conditions will need to be shared with their IM collaborators. A collaborator upon seeing an IM exchange go silent will not know that the user has just received an urgent telephone call and a misunderstanding can occur.

These issues can be addressed using the concept of dynamic status. With dynamic status, the current user context may be assessed in terms of the degree of attention that can be given to all or certain classes of IM exchanges. The assessment may be done manually or with partial or full degrees of automation. The degree may be expressed in the form of brief assertions such as “In a meeting”, “Busy”, “Away from the Office”. These various forms will provide a human understandable indication of the degree of attention that can be provided. These messages may also be linked by policy to the provision of certain messages that will convey this information directly. Thus, the user is able to specify per dynamic status, if and what he or she would like to push to the other party in an active IM session upon entering said status.

Dynamic status may be determined manually by providing a GUI window with tick-boxes for common status entries, such as “on the telephone”, “in a meeting”, etc. Alternatively, dynamic status may be determined automatically by accessing other software applications that provide an indication of the user's status. Non-limiting examples include the following:
the user's calendar application may have entries regarding meetings, appointments and other commitments. By collecting this information through the calendar application's API, the system will be aware when the user is busy with such a commitment. That is, the user can configure an Outlook Calendar to trigger a dynamic status change based on meetings/appointments, etc.; if the user's telephone system is PC based (such as Skype), is a VOIP (voice over IP) system or is a server based PBX system, the system of the invention may be able to determine when the user is on a telephone call;
if the user has set his email application to provide an out-of-office response, the system of the invention may collect this information through the API of the email application;
if a lack of recent keyboard activity has been detected, then the system may assume that the user is away from his desk. Conversely, the detection of recent keyboard activity will indicate that the user is at his desk;
the user has placed or received a call from a “special” individual or group;
the system may detect that the user is placing telephone calls on his/her cellular telephone rather than his/her office telephone, and assume that the user is away from his/her desk; or
the system may detect that the user is sending emails via his/her portable email device (such as a cellular telephone or Blackberry device) rather than his/her office PC, and assume that the user is away from his/her desk.
   Other options would also be clear to a person skilled in the art. All of the changes in presence mentioned are known and conveyed to the participants, not necessarily via a dynamic status change. For example, the remote end may be informed that the User has accepted a telephone call via telephony presence image changes, but the User's dynamic status does not necessarily change. Policies set in the current status could say of course, “when I connect to a call push the following to the other IM party . . . ” In the Mitel UCA (Unified Communicator Advanced) system, dynamic status is a component of one's presence. Presence in the UCA is composed of dynamic status (i.e. in the office, in a meeting, etc.), telephony presence or state (i.e. idle, on a call, etc), and IM presence or state (i.e. online, offline, away, etc.). In an embodiment of the invention, all of these may be presented separately (as separate images) for each contact in one's address book. Dynamic status also may have subcomponents of information: custom text which allows the user to convey specific additional information (for example, “working on quarterly report”), and possibly an advisory message which is driven by a PIM Calendar (for example, “next appointment at 2:00 PM”). The Mitel UCA offers voice, IM and dynamic status, presenting each separately to watchers. All are published to watchers and together allow the watcher to decide if and how to initiate communications with other users. Other UC-like products typically roll presence into one image, which has the advantage/simplicity of a single image, but lacks the granularity of the Mitel UCA approach. The invention may be applied to either environment.
   Initiation of an Exchange/Change of Status within an Exchange

Two cases are described here: the initiation of an IM exchange or within an IM exchange when the user status changes. In the case of initiation, a user may set preferences to:
a) ignore the exchange, which could be done with or without the provision of an explanation;
b) decline the exchange with an explanation;
c) accept the exchange with an explanation; or
d) accept the exchange.

The user may set preferences to supply explanations when their dynamic status changes within an exchange. Explanations may be sent to indicate that the user is not able to give full attention or when the context has recovered to indicate that the user can provide full attention to the exchange. Conversely, one may also update the distant party when the context has grown worse. A new event would arrive at the context engine, be processed to change status, and then an update is sent to the distant party. The distant party processes the received status and explanation in the same way as any other IM message arriving at the client, i.e. by simply displaying it. Thus, there is no change required in the remote user's system or software to implement such an embodiment of the invention.

In both cases, these preferences may be set for all users, specific users, or certain classes of users.

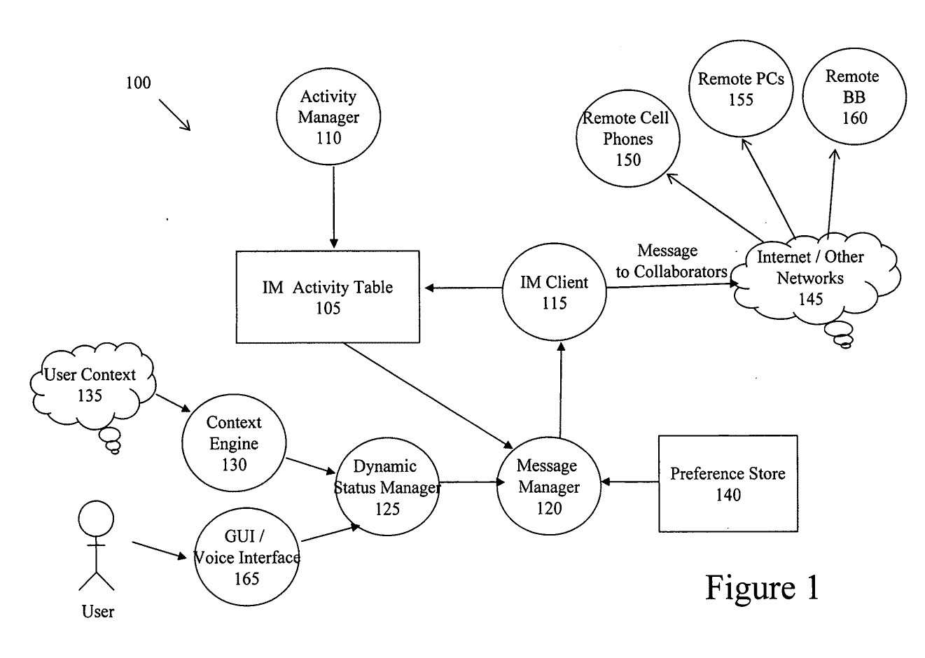

A block diagram of a suitable system 100 for implementation is shown in FIG. 1. The embodied system 100 consists of a number of IM Activity Tables 105 stored in one or more computer memories and a number of active programs 110, 115, 120, 125, 130 that operate on one or more computers or computer servers. The programs and tables may exist on the same or multiple distributed systems. They may connect to each other over a LAN, a company WAN, the commercial Internet or other network. These interconnections may be wired, wireless or a combination of these. The active programs are shown separately for purpose of clarity in the explanation of their functions, but they may be brought together into combined computer programs in some embodiments. They may be combined in any combination.

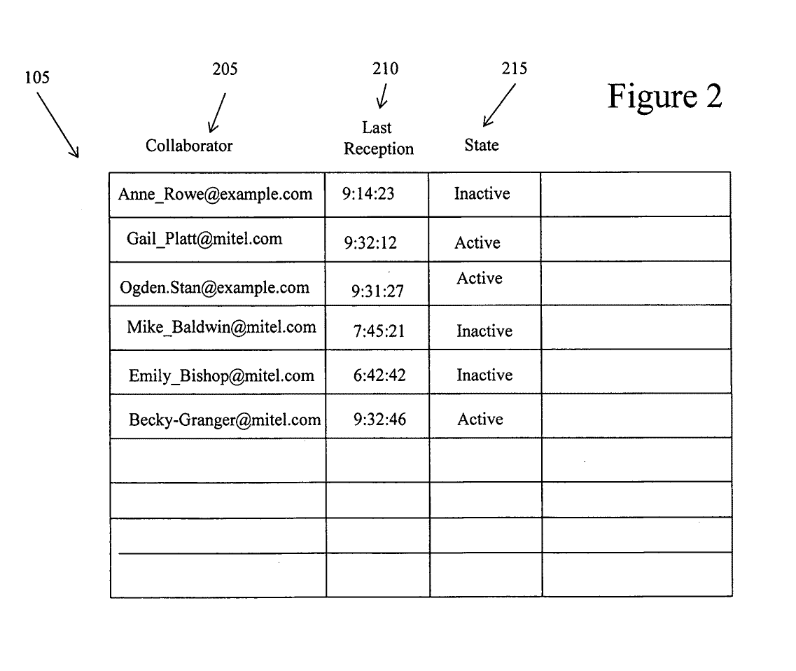

Explanatory messages will be sent, with the technology of this disclosure, on the initiation of an IM exchange or when the user dynamic status changes during an IM exchange. To accommodate this, the IM Activity Table 105 will be maintained within the memory of this system. Typically the IM Activity Table 105 will be stored on an Application/IM Server (i.e. a Unified Communication or UC Server), but is not restricted to this Server. Any location accessible to the UC Server would be sufficient. The IM Activity Table 105 is shown abstractly in FIG. 2. The IM Activity Table 105 will contain a list of the current IM exchanges in which the user is involved. The list will be maintained dynamically by the Activity Manager 110 so that newly initiated exchanges will be added to the list and terminated exchanges will be deleted from it.

The IM Client 115 is the user's existing IM client software application. The Message Manager 120 is a software module which determines whether to send a status update and/or explanatory message and what message to send. The Dynamic Status Engine 125 determines the dynamic status of the user by interacting with the User and/or the Context Engine 130. The User may enter status updates manually as described above, directly to the Dynamic Status Engine 125, for example, via a Graphic User Interface (GUI) or voice interface 165. Alternatively, the Dynamic Status Engine 125 may collect user context data 135 from the Context Engine 130, which in turn culls this information from the user's other software applications. The Preference Store 140, contains stored values representing the user's preferences, rules and policies. The implementation of rules and policies is described in greater detail hereinafter. Of course, IM messages may be sent to collaborators by the IM Client 115, over the Internet 145 or any other suitable data communication network or combination of networks (hard-wired, wireless, fiber optic, Ethernet, PSTN, ATM networks, etc.) Remote parties simply require any device which can read the transmitted IM messages, such as a cellular telephone 150, PC 155 or Blackberry device 160.

The basic information stored in the record for a given IM session will be the user id of the distant party/collaborator 205 as shown in FIG. 2. Other information may also be entered as fields in the IM Activity Table 105, such as the time of day of the last IM received, referred to as the Last Reception field 210. The IM client 115 will enter this value on the reception of any IM message. A third field in the record is the Active/Inactive field 215. This will contain a determination of the activity status within each IM exchange, based on the time elapsed from the reception of the last IM message.

Periodically (typically on the order of a few seconds), the Activity Manager 110 may scan the Last Reception field 210 for all current IM exchanges in the IM Activity Table 105. It will subtract the value in that field from the current time of day to determine the time elapsed since the last message was received on that exchange. It will compare this value to two values: the Activity Standard and the Termination Standard.

The Activity Standard may be used to determine whether an exchange is active or inactive. An active exchange is an exchange in which the user is actively participating. This will be determined by the amount of time that has been elapsed since the last message was received. If the user is sending frequent messages this is indicative of an active exchange. Infrequent messages will be indicative of an exchange that is in the background of the user's attention. If the time since the last received message is greater than or equal to the value of the Activity Standard, then the exchange will be determined to be inactive. If the elapsed time is of less duration or equal to the Activity Standard then the exchange will be said to be active. The determined value will be entered into the Active/Inactive field 215 of the corresponding record in the IM Activity Table 105.

The Termination Standard is used to determine whether an IM session has ended. If the time since the last message reception is greater than the Termination Standard, the IM exchange will be assumed to be abandoned. The Activity Manager 110 may then remove the IM exchange's record from the IM Activity Table 105. Typically, the administrator will set the Standard values for the Activity and Termination, using a reasonable default value.

These fields will be used by the Message Manager 120 in determining whether to send a status update and/or explanatory message and what message to send.

### Determination of Dynamic Status

The user's dynamic status will be determined by the Dynamic Status Manager (DSM) 125. This may be determined by input from the User as shown in FIG. 1, and in some embodiments, by input from the Context Engine 130. The Context Engine 130 receives User Context Data 135 and converts it to context data appropriate to the Dynamic Status Manager (DSM) 125. Conflicts between these two inputs will be determined by giving priority to the direct user input.

The User may be provided with an interface (for example a GUI or voice interface 165) by which he/she can communicate with the DSM 125. Through this interface the DSM 125 will supply the user with a representation of his/her current status. In one embodiment, this may be in the form of textual status messages. The system is provided with a default dynamic status list but the GUI 165 of the invention allows the User to create new status messages suited to their particular needs. Thus, it is not necessary to provide a multitude of message libraries of niche defaults, though that could be done. In other embodiments, graphical or tonal icons may be supplied. The default dynamic status list may include for example:
in the office;
in a meeting;
do not disturb;
at lunch;
working from home;
gone for the day;
out of the office; and
mobile.

The User may also customize their Dynamic Status List 320 via add, edit and delete functions to include messages such as:
in a Demo;
in the New York Office;
in the Seattle Office;
off Site;
mobile; and
working from home Office.
   As well, the Administrator may have functionality to add, edit and delete dynamic status options.

The User may be given the capability of entering a value for his/her current dynamic status. In one embodiment, these could be supplied by a set of radio boxes that allow the user to select one of a number of dynamic statuses. In one embodiment, the user may be given the additional capability of indicating that his/her dynamic status will be set automatically by an assessment of his/her current context. This selection may be done by use of an additional radio box other than the ones described above. So the user may have the capability of selecting one of a number of dynamic statuses or indicating that the selection should be made by an automatic assessment.

The automatic assessment of user dynamic status may be done by the Dynamic Status Manager 125 as shown in FIG. 1. The Dynamic Status Manager 125 may have access to user context data 135 such as location, current computer activity, co-presence (with whom he/she is), PIM Calendar meeting/appointment data also being factored in, that has been discerned from his/her current context by context agents. Suitable context agents are described in the Applicant's U.S. Pat. No. 7,415,104, entitled “Context Aware Call Handling System”, the contents of which are incorporated herein by reference. The Dynamic Status Manager 125 may have internal policies that analyze the current user context and make an assertion about the current user dynamic status. For example, the policies could include the following:
if the user telephone is on an active telephone call (either having received or placed the call) then the user dynamic status is “Busy”;
if the user's calendar indicates that he/she has a meeting and they have not sent any messages within that time period, then the user dynamic status is “Busy”;
if no activity has been detected for a prescribed amount of time, set the user's Dynamic Status to “Away from desk”;
if the User is on a telephone call with the boss, set the User's status to “Do not disturb”, blocking new call and IM attempts with the appropriate IM auto response;
when the User's calendar indicates that he/she is out of the office, change the User's dynamic status to Mobile;
when the User's GPS location indicates that he/she is in a specific location, change the User's Dynamic Status to “in the office”; and
when the User's calendar shows “Beginning of day” change the User's Dynamic Status to “in the office”.

### Setting of User Preferences/Policies

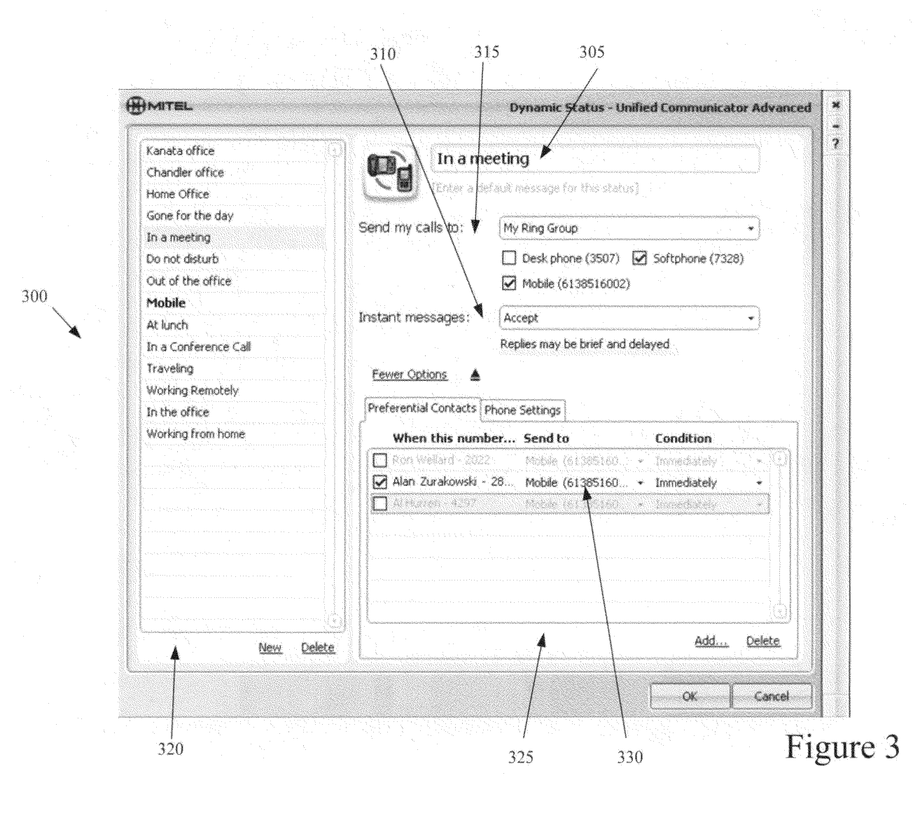

FIG. 3 shows an example of a GUI 300 that the User may use to set policies and preferences for the handling of IM sessions. In this non-limiting example, policies are set to be determined by the current user dynamic status alone. The user may select a dynamic status by use of the top drop down box 305. The user may then select the action to be performed in case of an incoming IM by use of the IM Option drop down box 310. The GUI 300 may allow preferences to be set on the condition of specific users or specific classes of users. The GUI may set preferences so that specific users or classes of users could be identified and selected actions taken on the basis of the user's dynamic status. These classes could include friends, relatives, family members, co-workers, team members, department members, bosses, and similar groups of individuals. Thus, the User may specify, for example:
allow all IMs;
show me as offline;
only allow Group X to IM me;
show me offline for duration Y;
show me as offline when my calendar says I am in a meeting; etc.
   Other forms of interfaces such as the use of structured English sentences similar to the exemplary policies shown above may also be supplied in other embodiments.

The GUI 300 of FIG. 3 also presents options for other call management features. For example, the “send my calls to” options 315 allow the User to control their call routing. The User is able to opt any device number into their routing based on Dynamic Extension. The List of Dynamic Statuses 320 provides a list of the different Dynamic Statuses that the user may choose to work in. Each Dynamic Status has different availability, routing, IM and presence options. New Dynamic Status states may be added, and existing ones deleted. Note that the dynamic status window 320 is used to select the status for review and editing, not to set the user's current status manually; that task is performed via the GUI or voice interface 165 described above. The Preferential Contact List 325 is used to define preferential contacts which will allow the user to identify callers/IMers that can reach them, while the balance of their contacts cannot. Similarly, “preferential groups” of contacts may also be defined, such as project groups of contacts. The balance of the preferential contacts window 330 shows phone settings which are peripheral to the IM discussion.

Handling of Newly Initiated IM Exchanges

As indicated above, a user may make one of four exemplary responses to the initiation of an IM exchange if their Dynamic Status indicates they are willing to accept an IM. These were indicated as:
a) ignore the exchange;
b) decline the exchange with an explanation;
c) accept the exchange with an explanation; or
d) accept the exchange.

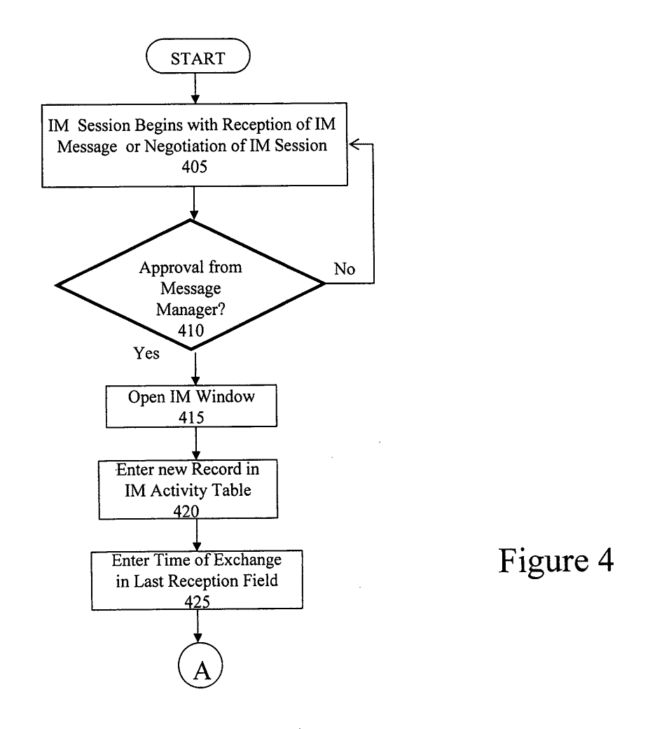

It is the intent of this section to indicate how these responses can be automated in order to enhance the mutual awareness of participants in the exchange to facilitate operational effectiveness of the organization. In one non-limiting embodiment, the IM client 115 of FIG. 1 will be aware that an exchange has been initiated. Referring to the flow charts of FIGS. 4 through 6, IM exchanges may begin in at least two ways 405. In one way, an IM session is negotiated with a rendezvous protocol such as SIP (RFC3261). In another way, an IM exchange may begin with the reception of a first IM message from a particular party. In this case, the IM client 115 will determine that no IM exchange exists with that party and open a window 415 to allow the display and entry of IM messages. In both of these cases, a new record 420 will be entered into the IM Activity Table 105. It is common in the art for an IM client 115 to open a new window to both display incoming IMs and to accept outgoing IMs. However, for this embodiment, the IM client may wait for an indication from the Message Manager 120 that it should open a window 410. This will enable certain IM exchanges that have been identified as SPAM or other forms of harassment to be silently ignored and not distract the user. If approval is rejected, then control returns to 405 to wait for a new exchange to be initiated.

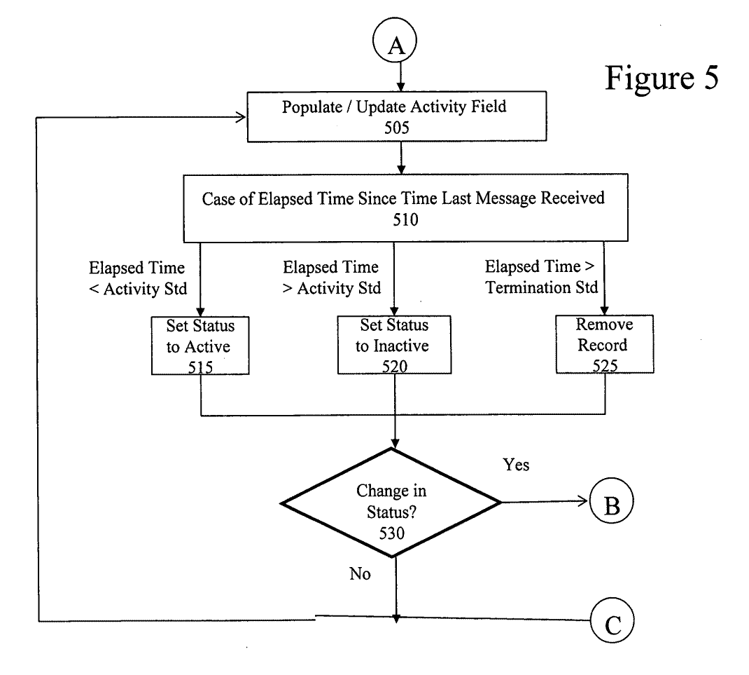

Once a new record has been entered into the IM Activity Table 105, the time of the last IM message reception is entered into the record 425. The record is then completed by populating or updating the activity status field 215 (see 505 of FIG. 5). As described above, the system periodically scans the Last Reception field 210 for all current IM exchanges in the IM Activity Table 105, subtracting the value in that field from the current time of day to determine the time elapsed since the last message was received on that exchange. A case statement 510 considers this elapsed time and:
if the elapsed time is less than the Activity Standard, the exchange is considered to be active and the state field 215 is set to “active” 515;
if the elapsed time is greater than or equal to the Activity Standard, the exchange is considered to be inactive and the state field 215 is set to “inactive” 520; and
if the elapsed time is greater than the Termination Standard, then the IM exchange will be assumed to be abandoned. The Activity Manager 110 will then remove the exchange's record from the IM Activity Table 525.

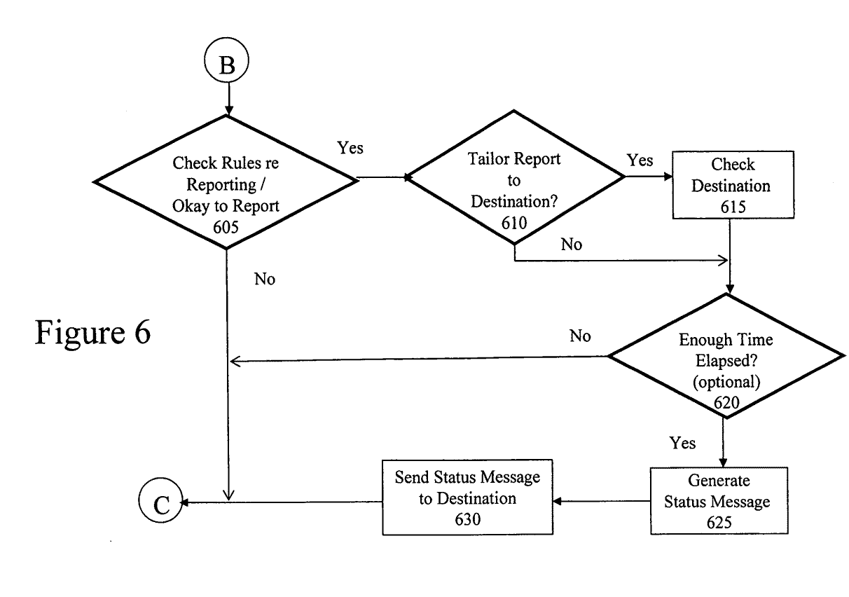

If a change of status has occurred 530, then control passes to FIG. 6 so that a status update and explanatory message may be sent. Otherwise, control simply returns to 505, to await another check on the user status.

The IM client 115 will, on the initiation of a new IM exchange, update the IM Activity Table 105 with a new record to hold data for the exchange. It will also inform the Message Manager 120 of the newly initiated exchange. The Message Manager 120 will have access to a set of policies that are maintained within the Preference Store 140 of FIG. 1. The Message Manager 120 will execute the policies that are stored there, per 605 of FIG. 6. It will provide as input to these policies the user's current dynamic status, the user id of the distant party initiating the IM exchange, the time of day, and any other pertinent factors. These policies may be of the form of condition-action pairs; that is, if certain parameters of the user state are of a certain value then perform certain behaviors. These behaviors may include, for example:
a) instructing the IM client to open the IM exchange;
b) instructing the IM client to emit a specific message but to not open the IM exchange;
c) instructing the IM client to open the IM exchange and emit a specific IM message; or
d) instructing the IM client to take no further action on the exchange.

Examples of policies that could be maintained within the Preference Store 140 are:
a) if my Dynamic Status is “Busy” AND the Distant Party is *@example.com then Decline with “Sorry I am Busy Right Now”;
b) if the Distant Party is Ann_Rowe@example.com then Ignore;
c) if my Dynamic Status is “In a Meeting” then Accept with “I'm in a meeting and will not be able to respond very quickly”; and
d) if my Dynamic Status is “Available” then Accept.

If it is determined at 605 that a message should not be sent, control returns to 505 of FIG. 5. If it is determined at 605 that a message should be sent, then it is determined at 610 whether the message should be tailored to suit the destination. If not, then a standard message is prepared at 625 and sent at 630, with control then returning to 505 of FIG. 5 (the operation of the optional hold-over timer 620 is described hereinafter). If the message is to be tailored to the destination, then the destination is identified at 615 before the custom message is prepared at 625 and sent at 630.

These preference policies may be set by the user, a system administrator, an automatic system management program, be hard coded into the programming of the system, or be set by a combination of these. For example, a system administrator may have the ability to set policies that will enforce company directives, such as rejecting Ns from outside of the company or its supply chain. Users may also set policies to customize system operation to the needs of their role, for example, through a GUI or other interface. An example of such a GUI 300 is shown in FIG. 3 and is described above. The IM client 115 may be implemented with an API (application programming interface) so that it can communicate with other applications but typically the client would query other applications, and likely would not be queried itself by other applications.

There may be cases in which there will be a conflict between user and administrator set policies. In such a case, an incoming IM will be declared to be handled in one way by the user policy, but in a different way by the administrator policy. In such a case, it is generally desirable that the company policy (i.e. the administrator policy) prevail. This may be done by a conflict resolution mechanism such as that described in the Applicant's U.S. Pat. No. 7,415,104 referred to above. In short, IM routing is handled on the server-side via respective engines or services. These engines and service modules are server-side where they have access to all of the information required (i.e. caller and called parties and their associated routing rules), and also to ensure that routing is affective even without the desktop client running. The rules engine maintains the required information in memory to facilitate optimal performance. The routing engine may communicate with the involved parties using SIP (for example), an industry standard protocol.

The issue of unwanted IMs in the form of SPAM and other forms of harassment can be controlled by use of automatic programs which will detect and reject such messages. System administrators may choose to have user preferences updated by such programs to ease the burden of SPAM on company efficiency. As before, such policies will typically prevail in any conflict over user policies.

### User Initiated Exchanges

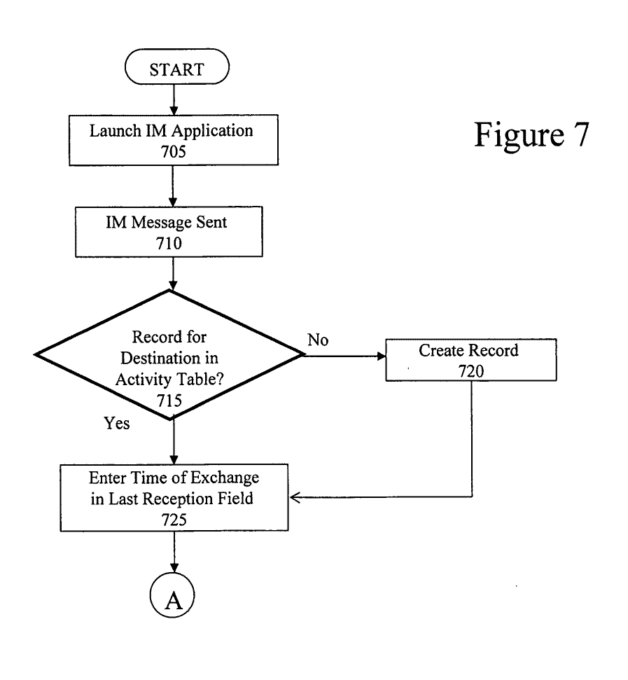

The above description has assumed that a distant party has initiated an IM exchange and proved means to indicate how the exchange should be dealt with. It will also be common for the local user to initiate an IM exchange. A method for performing such a process is presented in the flow chart of FIG. 7, which replaces FIG. 4 for this case. Note that FIG. 7 continues on with FIGS. 5 and 6.

Returning to FIG. 7, it will be necessary to monitor the active or inactive status of these exchanges, in order to handle changes in the User's dynamic status. This can be performed by the IM Client 115 which will examine the IM Activity Table 105 after the IM Client 115 is launched 705 and an IM message sent 710. If it is determined 715 that no IM exchange record exists for the party to whom the message will be sent, the IM Client 115 will create a new record in the table for the IM exchange 720. The IM Client 115 will enter the current time 725 as the value for the Last Reception field 210. In this way, the IM activity table 105 will be maintained for all exchanges, both those initiated by the local party and those initiated by distant parties.

The balance of the process is the same as that of the generation of IM messages and sessions from a distant party, per FIGS. 5 and 6.

### Handling of Status Changes

As described above, the expectations for the attention supplied to IM sessions will change if the user's dynamic status changes. For example, a user may be actively involved in an IM exchange but have to suspend their attention to take a phone call or leave to attend a meeting. In such a case, it would be desirable for IM collaborators to be informed of this change of attention level. Informing IM collaborators of this change can also be done by the Message Manager 120 by use of policies stored in the Preference Store 140.

In some embodiments, it may be found suitable to differentiate between active and inactive IM exchanges for the provision of explanatory messages regarding change in dynamic status. The provision of an IM message may distract the attention of the recipient. So in the case in which an IM exchange is inactive, it may be considered counterproductive to inform the distant party of changes in status. In these cases, the active/inactive information maintained within the IM Activity Table 105 can be used to identify inactive exchanges and determine that they do not require a message regarding the change in dynamic status.

In some embodiments, a policy will be set so that entry to a new dynamic status will send a message that is specific to this status. For example, a change to a BUSY status will trigger the sending of a specific IM message. In other embodiments, the messages may also be based on the identity of specific distant parties or classes of distant parties. So, in this example, internal and external parties may, in some embodiments, receive different messages for the same status change.

In other embodiments it may be desirable to time the change in status so that large numbers of update messages are not sent. In one example, a user may take a telephone call that lasts only a few seconds or leave his/her desk for a few seconds. This may cause a momentary change in dynamic status but will not affect the attention supplied to IM exchanges. In such cases, a hold over timer can be used to detect changes that are spurious in this regard and so prevent distracting messages being sent to distant parties. That is, if a sufficient length of time has not passed since the previous status update/explanation message was sent 620 (see FIG. 6), then control returns to 505 of FIG. 5, without sending a status update/explanation message. If a sufficient length of time has passed, then processing continues with 625 where a status message is generated to the proper parameters, and is transmitted to the distant party at 630.

### Suppression of Incoming Messages

It is known in the art for the display of incoming IM messages to be suppressed if certain applications are in operation. For example, Microsoft™ provides the option of suppressing display of incoming messages if PowerPoint™ is in presentation mode. However, this option is deficient for the same reasons described in the Background to the Invention above. Senders of suppressed IMs will be unaware that their intended recipient is engaged in an activity that will prevent him/her from considering the messages as they have been sent. Thus, misunderstanding may ensue.

This deficiency may be addressed by providing further policy options to the user. In certain embodiments, policies of the form:
If my Dynamic Status is “Presentation” Then Suppress Display With “Sony I am Presenting Right Now”

In certain embodiments this may be implemented with the arrangement of FIG. 1. The IM Client 115 will report each incoming IM to the Message Manager 120. Policies relating to the reception of individual message will be stored in the Preference Store 140. The Message Manager 120 will operate these polices and make a decision about what to do with the current IM. It will send this decision to the IM Client 115. In certain embodiments, these decisions may be to either display the message or to suppress it with an explanation. The IM Client 115 will then execute the decision. For the example described above, if the user is in the Presentation dynamic status, all incoming IMs will be suppressed and a corresponding explanatory message sent to the distant party. The Preference Store 140 obtains context information from the Powerpoint application via the desktop client, querying the underlying operating system (OS).

### Options and Alternatives

The invention has been described by means of a few examples, but of course, could easily be applied to other systems or be implemented in different ways. This description is directed to an implementation of the invention as an integral part of a unified communications system but it could also be implemented as a separate application, external to an existing IM client. The invention could also be applied to other semi-synchronous communication systems, such as SMS (short message service). A unified communications server (UC server) would need to be employed as an SMS Gateway server-side. The routing and handling of SMS/text messages could then be handled via a common engine in a manner similar to that described herein with respect to IM traffic.

Numerous modifications, variations and adaptations may be made to the particular embodiments described above without departing from the scope of the patent disclosure, which is defined in the claims.

What is claimed is:

1. A method of semi-synchronous communication comprising:
establishing a semi-synchronous communication between a user and a second party;
responding to a change in said user's level of attentiveness to said semi-synchronous communication by:
generating a status message addressed to said second party;
populating said generated status message with an indicator of said user's new level of attentiveness, and an explanation; and
transmitting said explanatory status message to said second party.

2. The method of claim 1 further comprising generating a record of said semi-synchronous communication in an Activity Table, said record including identification of said second party.

3. The method of claim 1 further comprising detecting a change in said user's level of attentiveness by detecting a change in said user's dynamic status.

4. The method of claim 3 comprising detecting a change in said user's level of attentiveness by detecting that:
the user has placed a telephone call;
the user has received a telephone call;
the user's electronic calendar indicates that he/she has a meeting scheduled;
a lack of recent keyboard activity has been detected;
recent keyboard activity has been detected;
the user has placed or received a call from a “special” individual or group;
dynamic status has changed; or
dynamic status has changed to “Gone home”.

5. The method of claim 1 further comprising populating said explanation with consideration for the identity of said remote user.

6. The method of claim 1 further comprising populating said explanation with consideration for the class of said second user.

7. The method of claim 3 further comprising populating said explanation based on other context parameters of said user.

8. The method of claim 5 further comprising populating said explanation based on other context parameters of said second party.

9. The method of claim 1 wherein said transmitting comprises transmitting said explanatory status message only if sufficient time has elapsed since a previous explanatory status message was sent, thereby preventing a multiplicity of nuisance messages from being transmitted.

10. The method of claim 1 further comprising populating said explanation using a set of rules.

11. The method of claim 10 wherein said rules comprise administrator-defined rules and user-defined rules.

12. The method of claim 11 wherein said populating said explanation with said administrator rules and said user rules further comprises resolving conflicts between said administrator rules and said user rules.

13. The method of claim 1 wherein said semi-synchronous communication is an Instant Message (IM) session.

14. The method of claim 1 further comprising the step of responding to a local application suppressing display of Instant Messages by generating, populating and transmitting a corresponding explanatory status message to said second party.

15. A communication device having a user associated with it, said communication device comprising:
means for providing semi-synchronous communication with a second communication device; and
means responsive to a change in said user's level of attentiveness to said semi-synchronous communication by:
generating a status message addressed to said second communication device;
populating said generated status message with an indicator of said user's new level of attentiveness, and an explanation for the change in the level of attentiveness; and
transmitting said explanatory status message to said second communication device.

16. A system for semi-synchronous communication comprising:
a first communication device having a user associated with it;
a second communication device; and
a communication network interconnecting said first and said second communication devices,
wherein said first and said remote communication devices being operable to participate in a semi-synchronous communication; and
said first communication device being operable to respond to a change in said user's level of attentiveness to said semi-synchronous communication by:
generating a status message addressed to said second communication device;
populating said generated status message with an indicator of said user's new level of attentiveness, and an explanation; and
transmitting said explanatory status message to said second communication device.

17. The system of claim 16 wherein said first communication device is operable to generate a record of said semi-synchronous communication in an Activity Table, said record including identification of said remote communication device.

18. The system of claim 16 wherein said first communication device is operable to detect a change in said user's level of attentiveness by detecting a change in said user's dynamic status.

19. The system of claim 18 wherein said first communication device is operable to detect a change in said user's level of attentiveness by detecting that:
the user has placed a telephone call;
the user has received a telephone call;
the user's electronic calendar indicates that he/she has a meeting scheduled;
a lack of recent keyboard activity has been detected;
recent keyboard activity has been detected;
the user has placed or received a call from a “special” individual or group;
the dynamic status has changed; or
the dynamic status has changed to “Gone home”.

20. The system of claim 16 wherein said semi-synchronous communication is an Instant Message (IM) session.
